(19) United States
(12) Patent Application Publication
(10) Pub. No.: US 2016/0277481 A1
(43) Pub. Date: Sep. 22, 2016

(54) DATA TRANSFERRING METHOD, DEVICE AND SYSTEM THEREOF

(71) Applicant: Tencent Technology (Shenzhen) Company Limited, Shenzhen (CN)

(72) Inventor: Lin YANG, Guangdong (CN)

(21) Appl. No.: 15/169,046

(22) Filed: May 31, 2016

Related U.S. Application Data
(63) Continuation of application No. PCT/CN2014/095170, filed on Dec. 26, 2014.

(30) Foreign Application Priority Data
Dec. 31, 2013 (CN) 201310754458.1

(51) Int. Cl. H04L 29/08; G06Q 50/00; G06Q 20/40; H04L 12/58; G06Q 20/22

(52) U.S. Cl. CPC H04L 67/06; H04L 51/32; G06Q 20/223; G06Q 20/407; G06Q 50/01

(57) ABSTRACT

In a method, device and system for transferring data, a request is received by a server from an initiating user client for transferring data, where the request includes the initiating user identification and information about a target for which the data is transferred. A data transfer interface that corresponds to the target is created by the server and published on a social information display platform that corresponds to the initiating user identification. When a trigger operation is detected in the data transfer interface from one or more user clients, a trigger request is sent to the server to transfer data from the one or more user's accounts to an account associated with the target information. The method, device and system improve the security of the data transfer process.

This application is a continuation of International Patent Application No. PCT/CN2014/095170 filed Dec. 26, 2014, which claims priority to Chinese Patent Application No. 201310754458.1, filed Dec. 31, 2013 in the Chinese Patent Office, both of which are hereby incorporated by reference in their entireties.

### TECHNICAL FIELD

The present disclosure relates to network technology field, and more particularly to a data transferring method, a device and a system thereof.

### BACKGROUND OF THE INVENTION

As network technology develops, network trading becomes more and more popular and payment platforms for transferring payments are utilized. For example, service providers may offer certain services, commodities or resources, which may be bought and paid for by users with real or virtual money from their individual accounts, or may be exchanged using points.

During a conventional process for paying for a commodity for another user, a URL that is used for transferring payment for the commodity may be easily confused since the same commodity name or service provider name may be used in different URLs. Therefore it may be difficult for payers to distinguish whether a URL is pointing to the true destination for the commodity payment. This situation may create security problems such that security of a user's account that is used for paying for the commodity may be in jeopardy.

### SUMMARY

The present disclosure provides a method, a device and a system for transferring data.

In an aspect of the disclosure, a data transfer method may include:
receiving a request for transferring data from an initiating user client, where the request for transferring data may carry at least initiating user identification and target information;
creating a data transfer interface that corresponds to a target, according to the target information; and
publishing the data transfer interface on a social information display platform that corresponds to the initiating user identification.

In an aspect of the disclosure, a data transfer device may include:
a receiving module, arranged for receiving from an initiating user client, a request to transfer data, where the request to transfer data may include at least initiating user identification and target information;
an interface creating module, arranged for creating a data transfer interface that corresponds to a target according to the target information; and
a publishing module, arranged for publishing the data transfer interface on a social information display platform that corresponds to the initiating user identification.

In an aspect of the disclosure, a data transfer method may include:
after a first user client receives a request for displaying a data transfer interface, displaying a data transfer interface which is provided by a social information display platform that corresponds to the initiating user identification;
after detecting a trigger operation in the data transfer interface, sending a trigger request to a server, where the trigger request may be used for triggering the server to transfer data.

In an aspect of the disclosure, a data transfer device may include:
a displaying module, adapted to display a data transfer interface that may be provided by a social information display platform that corresponds to an initiating user identification, after a first user client receives a request for displaying the data transfer interface;
a triggering module, adapted to send a trigger request to a server after detecting a trigger operation for the data transfer interface, where the trigger request may be used for triggering the server to transfer data.

In an aspect of the disclosure, a data transferring system may include:

a server adapted to:
receive a request for transferring data from an initiating user client, where the request for transferring data may include at least initiating user identification and target information;
create a data transfer interface that corresponds to a target according to the target information; and
publish the data transfer interface on a social information display platform that corresponds to the initiating user identification; and

a client adapted to:
initiate the request for transferring data;
display the data transfer interface that is provided by the social information display platform that corresponds to the initiating user identification after receiving a request for displaying the data transfer interface;
send a trigger request to the server after detecting a trigger operation in the data transfer interface, where the trigger request may be used for triggering the server to transfer data.

The disclosure is not limited to the transfer of any specific type of data and any suitable data may be transferred. In some embodiments of the disclosure, the data being transferred may comprise a medium or unit for an exchange or transaction, for example, real or virtual money or points used in a transaction. In this regard, an account may have a value that represents a medium of exchange. However the disclosure is not limited in this regard and other types of data may be transferred relative to the target information. Furthermore, a target may be any subject for which the data is transferred or the purpose for transferring the data. In one example, a target may be an item or service that is purchased where one or more people may contribute to the payment of the item by transferring the data over a network. However, the disclosure is not limited to any specific kind of data and any type of data may be transferred with respect to any type of target.

In operation, a data transfer interface may be created and published on a social information display platform such that the social information display platform may serve as a host of the data transfer interface without restricting specific users from executing data transfers. In this manner, improvements in the flexibility of data transfers and in applying a data transfer method to different data transfer situations may be realized. Furthermore, the data transfer interface displayed on the social information display platform may be accessed based on users logging onto a client. This aspect may provide security benefits where security vulnerabilities are difficult to avoid in traditional methods using URLs when transferring data. Therefore, embodiments of the disclosure may improve security in data transfer operations, and therefore, may improve security of a user's account.

### BRIEF DESCRIPTION OF THE DRAWINGS

The present disclosure may be better understood with reference to the following drawings and descriptions which include non-limiting and non-exhaustive embodiments of the disclosure. The drawings described hereinafter include only some embodiments related to the disclosure. Other drawings may be determined by those skilled in the art based on these drawings, without creative effort.

FIG. 1 is a flowchart for transferring data in accordance with an embodiment of the disclosure.

FIG. 2 is a flow diagram for transferring data in accordance with an embodiment of the disclosure.

FIG. 3 is a block diagram that represents a server device for transferring data in accordance with an embodiment of the disclosure.

FIG. 4 is a flowchart for transferring data in accordance with an embodiment of the disclosure.

FIG. 5 is a block diagram that represents a data transferring device in accordance with an embodiment of the disclosure.

FIG. 6 is a block diagram that represents a data transferring system according to an embodiment of the disclosure.

### DETAILED DESCRIPTION OF ILLUSTRATED EMBODIMENTS

Other aspects, features, and advantages of this disclosure will become apparent from the following detailed description when taken in conjunction with the accompanying drawings.

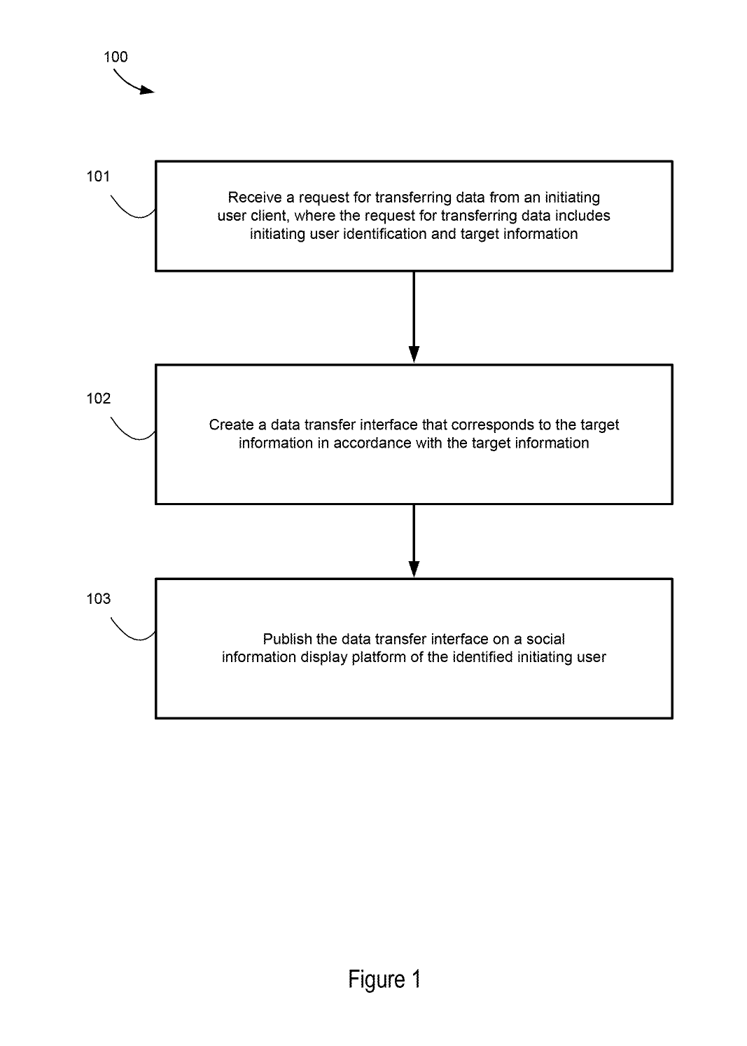

FIG. 1 is a flowchart for transferring data in accordance with an embodiment of the disclosure. Referring to FIG. 1, a method for transferring data may comprise the following steps.

Step 101 may include receiving a request for transferring data from an initiating user client, where the request for transferring data may include at least, initiating user identification and target information.

Step 102 may include creating a data transfer interface that corresponds to the target information according to the target information.

Step 103 may include publishing the data transfer interface on a social information display platform that corresponds to the initiating user identification.

In some embodiments, the initiating user identification may be associated with an initiating user that initiates the request for transferring data utilizing the initiating user client. The target information may be associated with a target for which the data is transferred.

In some embodiments, a data transfer interface may be created and published on a social information display platform in a situation where users may wish to transfer data. The social information display platform may serve as a carrier of the data transfer interface where specific users may not be restricted from executing data transfers. This method of transferring data may largely improve flexibility in executing data transfers and applying such data transfers to different situations. Furthermore, a data transfer interface displayed on a social information display platform may be accessed based on a user logging onto a client, thereby improving security of data transfer operations and security of the user's account. However, when using a URL for transferring of data, it may be difficult to manage ways of avoiding security vulnerabilities.

In some embodiments, after publishing the data transfer interface on the social information display platform that corresponds to the initiating user identification, the method may comprise further steps. The further steps may include receiving from a first user, a request for triggering the data transfer interface to call a first account that corresponds to or is associated with the first user, subtracting an amount of data or exchange units indicated by the first user, from the first account, and then adding a corresponding amount of data or exchange units to a second account that corresponds to or is associated with the target or target information, which may be utilized for receiving data or payments for the target.

The method of creating a data transfer interface that corresponds to the target according to the target information may include obtaining a second account that corresponds to or is associated with the target according to the target information and may include assigning the second account as a target transfer account that may be utilized to receive data or payments for the target when utilizing the data transfer interface.

In some embodiments, the method may comprise obtaining a total amount due or price corresponding to the target and/or according to the target information. The total amount due may be utilized as an upper limit for data to be transferred through the data transfer interface. Further, a minimum transfer amount may be obtained for the target information. The minimum transfer amount may be utilized as a lower limit for the data to be transferred through the data transfer interface.

In some embodiments, after publishing the data transfer interface on the social information display platform that corresponds to the initiating user identification, the method may include further steps. For example, in instances when the data transfer operation by the first user is complete, actual transferred data information for the target may be sent to the first user client. The information may be based on a value of the amount subtracted from the first account and the amount transferred through the data transfer interface.

In instances when a sum of the amount transferred through the data transfer interface reaches the total amount or the price of the target, the actual transferred data value for the target may be sent to clients of the users that participated in transferring the data.

In instances when the data transfer operation by the first user is complete, a contribution percentage of data transferred indication which may correspond to a contribution made by the first user in paying for the target may be sent to the first user client. The contribution percentage of data transferred may be based on a ratio of the amount subtracted from the first account to the total amount due or price of the target according to the target information.

In some embodiments, after publishing the data transfer interface on the social information display platform that corresponds to the initiating user identification, the method may include further steps. For example, in instances when a data transfer operation fails to be performed by any user within a first preset time limit, the data transfer interface may be closed. Moreover, in instances when a sum of the amounts transferred through the data transfer interface within a second preset time limit is less than a total amount or price according to the target information, the data transfer interface may be closed, and the amounts transferred by the users may be refunded to their own accounts respectively.

In some embodiments, after publishing the data transfer interface on social information display platform that corresponds to the initiating user identification, the method may comprise further steps. For example, when a request for querying progress of a data transfer from a second user is received, a current actual transferred data value for the target made by the second user may be sent to a second user client. Moreover, when a request for querying a contribution percentage of data transferred from a third user is received, a contribution percentage of data transferred indication for payment made by the third user for the target information may be sent to a third user client.

Additional embodiments may be obtained by making any combination of the embodiments mentioned above, which will not be described again.

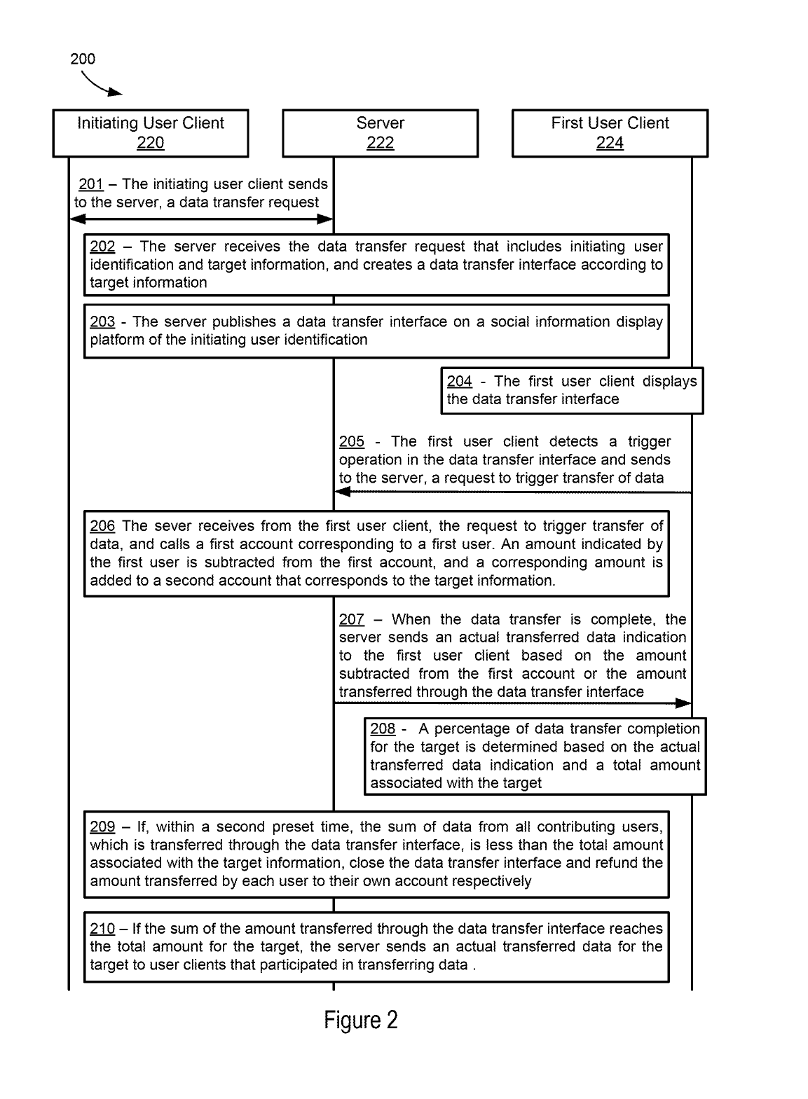

FIG. 2 is a flow diagram for transferring data in accordance with an embodiment of the disclosure. Referring to FIG. 2, there is shown a system 200 that may include an initiating user client 220, a server 222 and a first user client 224. Although only one first user client 224 is illustrated in FIG. 2, additional clients may be included in the system for transferring data, which may function in a similar manner as the first user client 224 with respect to the methods described herein.

The server 222 may be communicatively coupled with the initiating user client 220 and the first user client 224, for example, via a network. A client may comprise a hardware and/or software computing system that may access services and/or resources offered by another hardware and/or software computing system, for example, a server. A server may comprise a hardware and/or software computing system that may respond to requests or commands from another hardware and/or software computing system, for example, a client.

As shown in FIG. 2, a method for transferring data may include the following steps.

In step 201, the initiating user client 220 may send a request for transferring data to the server 222. The request for transferring data may include, at least, identification of an initiating user and target information.

The initiating user client 220 may refer to a client which may be located near to or used by a user that initiates a data transfer process.

In some embodiments, after an initiating user selects a target using the initiating client 220, the initiating user client 220 may send target identification to the server 222, and the server 222 may create target information based on the target identification and send it to the initiating user client 220, so that the initiating user client may obtain it. When the initiating user wishes other users to transfer data for him, the initiating user may trigger a data transfer operation via a data-transfer option provided by the client 220. When activation of the data-transfer option is detected, the initiating user client 220 may send a request for transferring data to the server, where the request may include, at least, the initiating user identification and information about the target.

For example, the initiating user may initiate the data transfer operation using a social information display platform that corresponds to the initiating user identification. The social information display platform may have an option to initiate the data transfer operation, and the initiating user client may send a request for transferring data to the server when the option on the social information display platform is triggered by the initiating user.

With respect to the target information, besides a total amount or price corresponding to the target, the target information may include a name of the target and/or its description information. Furthermore, the target information may identify or be associated with only one target or with a target set which may be composed of multiple targets.

In an example of an embodiment, in instances when an initiating user selects a toy on a page provided by an instant messaging client, and the user indicates or selects to buy the toy, the instant message client may send identification of the toy and/or link information for the page that includes the toy to the server. The server may create target information including a total amount, for example, the total value of money or price for the toy according to the identification of the toy and/or the link information. The server may then return the target information to the instant messaging client, so that the instant messaging client may use the target information to initiate a payment process.

In step 202, the server 222 may create a data transfer interface according to information about the target after the server receives the request from the initiating user client for transferring data, where the request may include, at least, the initiating user identification and the target information.

The data transfer interface may be encapsulated in a log message or a status message, or may be included in a web page, for example. The data transfer interface may be used to prompt or indicate to users executing a data transfer, a specific amount or value of the data that is to be transferred for the target and the initiating user.

Step 202 may include the following steps but is not limited in this regard.

Step 202, may include obtaining a second account that may correspond to or may be associated with the target according to the target information.

In one example, the target information may include second account number information of the target provider, by which a second account corresponding to or associated with the target information may be obtained.

When the server 222 receives the request for transferring data from the initiating user client 220, an object account, for example, the account of the target provider may be needed by any user performing a data transfer operation. The second account may be determined so that a debit operation may be completed successfully.

Step 202 may include assigning the second account as a target data transfer receiving account for the data transfer interface.

Although the data transfer process may be initiated for the target information, in one example, the data transfer process may be achieved by firstly creating a data transfer interface for considering the initiating user identification as a debit object, then modifying this data transfer interface according to the request for transferring data, so that the debit object would not be restricted by this interface. In some embodiments all types of debit objects may perform data transfer through the interface. Data may be deducted from a debit object and then transferred through the data transfer interface.

The process of creating the data transfer interface corresponding to the target information of step 202 may include additional steps.

In some embodiments a total amount corresponding to the target according to the target information may be obtained, and may be utilized as an upper limit for the value of the data, for example, as money or points, which is to be transferred through the data transfer interface.

As the total amount may be utilized as the upper limit of the value of the data to be transferred through the data transfer interface, the actual data transferred by other users, for example, the first user client 224 or additional user clients that may contribute data transfers for the target, would be less than or equal to the total amount.

A reason for such a limitation may be to limit the total amount for the data transfer process started by the initiating user, for example, to limit the maximum amount of the data transferred, so that amounts for other users' actual transferred data would be less than or equal to the total amount. Such a limitation to the amount of data to be transferred may improve the flexibility of the data transfer process and reduce the threshold of data transfers, so as to attract user clients to participate. For example, if the upper limit of the amount to be transferred is 100 dollars, then the actual transferred data by each user client at the time of transferring data is not more than 100 dollars.

In some embodiments, a minimum transfer amount may be obtained from the target information where the minimum transfer amount may be utilized as a lower limit for the value of the data to be transferred through the data transfer interface.

The initiating user may set a lower limit for the data transfer interface in order to limit the transfer data range. For example, if the lower limit of the value of the data to be transferred is 1 dollar, then the actual data transferred by each user client at the time of transferring data may not be less than 1 dollar.

Furthermore, in order to further limit the range of the value of the data to be transferred, the initiating user may also set an upper limit and a lower limit for the data to be transferred for the data transfer interface. For example, if the lower limit of the data to be transferred is 1 dollar and the upper limit of the data to be transferred is 100 dollars, the actual data transferred by each user client at the time of transferring data is not less than 1 dollar and not more than 100 dollars.

In addition, different transfer data businesses may utilize the data transfer interface in different pages that may correspond to different page templates. The page template may be filled with the total amount corresponding to the target information, the initiating user identification, and so on, to enable a user who visits the page to view and determine, for example, whether the initiating user is a friend, whether the total amount is correct, or to obtain the situation surrounding or purpose of the data transfer according to the current page content. Furthermore, the page template may also be a page frame allowing users to add controls according to the demands of the situation so as to individualize the page. For example, a timer control may be added to the page template to make the data transfer interface open at a certain time, thereby limiting a period of time that transfer of data is allowed for the page. Moreover, a counter control to count the number of users visiting the current page or transferring data may be added to the page template. A countdown timer control may be added in order to start a countdown for the expiration time of the current page. However, the disclosure is not limited with respect to any specific controls that may be added to the page template. The page may include the name of the target as well as other items so that a user can determine the initiating user and payment details.

In step 203, the server 222 may publish the data transfer interface on a social information display platform corresponding to the initiating user identification.

The server 222 may use a form of web links or page thumbnails when publishing the data transfer interface. The web links may lead to the social information display platform of the initiating client, but may not trigger a jump to other applications. In this manner, a seamless handover may be ensured and a jump may proceed from the current client directly to the data transfer interface.

In addition, viewing the data transfer interface based on the same client's page may save repeated login procedures that may be required when jumping to other clients. Different functions based on the same account may pass users' login status since the current client has already been in a login-in state, in this way, foregoing the complex operation of logging in and realizing a smooth jump process.

In step 204, after a first user client 224 receives a request for displaying a data transfer interface, displaying the data transfer interface which is provided by a social information display platform corresponding to the initiating user identification.

As a first user on a relationship chain of the initiating user identification, the first user may obtain the data transfer interface by visiting the social information display platform that corresponds to the initiating user identification, and may trigger the display for the data transfer interface.

In step 205, after detecting a trigger operation to the data transfer interface, a trigger request may be sent to the server 222, and the trigger request may be used to trigger the server 222 to transfer data.

In step 206, the server 222 may receive the request for triggering the data transfer from a first user, and may call a first account corresponding to or associated with the first user. An amount or value determined by input from the first user may be subtracted from the first account. The corresponding amount or value may be added to a second account that corresponds to or is associated with the target or target information.

For a closed social information display platform, information published on the initiating user's social information display platform may be visited only by the users that are on the relationship chain of the initiating user. In this case, the first user client 224 may be a client used by or located where any one of the users on the relationship chain of the initiating users is located. For an open social information display platform, information published on the initiating user's social information display platform may be visited by any user including registered users and non-registered users on the social information display platform. In this case, the first user client 224 may be a client used by or located where any user is located.

In an embodiment of the disclosure, the first user may have a corresponding or associated first account. The first user may serve as the owner or the user of the first account, who may be authorized to perform a data transfer operation using the first account.

The page displayed for the data transfer interface may provide an input box that allows the first user to input an amount of money to be transferred, so as to allow the server 222 to call the first account indicated by the first user, subtract a corresponding amount indicated by the first user from the first account. A corresponding amount may be added to a second account that corresponds to or is associated with the target information after the actual amount of money to be transferred is obtained and a trigger request is received. For a purchase or an AA payment scenario where multiple users contribute to a total amount, before adding the corresponding amount to the second account associated with the target information, a further step may include adding the amount subtracted from the first account to a managed account, and then adding that same amount to the second account associated with the target information, from the managed account.

Furthermore, when receiving a trigger request for the data transfer interface from the first user, the server 222 may obtain a user identification and password input by the first user, and may login to the corresponding account based on the user identification and password to perform the data transfer operation.

In step 207, when the data transfer operation of the first user has been completed, an actual transferred data indication for the target information may be sent to the first user client 224 according to the amount subtracted from the first account and the amount transferred through the data transfer interface.

In some embodiments, according to an amount subtracted from a user's account and an amount of the value of data transferred through the data transfer interface previously, for example, an accumulated amount transferred previously, the server 222 may provide a current completion percentage of data transferred for the target information, to the user's client, for example, the initiating user client 220 or the user client 224, when a user transfers data through the data transfer interface. The current completion percentage of data transferred may be a percentage value that may be determined by the user's client, for example, the user client 224, according to a sum of the amount subtracted from the user's account and an accumulated amount transferred through the data transfer interface to the user's client by the server 222, in relation to the total amount or price for the target, where the total amount may be based on the target information. For example, for a user A, when the server 222 confirms that a user A transferred 100 dollars through the data transfer interface, the accumulated amount of data transferred through the data transfer interface is 500 dollars and the total amount corresponding to the target information is 1000 dollars, then the current completion percentage of data transferred for the target information may be 60%. Furthermore, the process of determining the completion percentage of data transferred may be performed by the server 222, for example, the server 222 may determine the completion percentage of data transferred based on the total amount corresponding to the target information and the sum of the amount subtracted from the user's account and the amount transferred through the data transfer interface, and may send the determined completion percentage of data transferred to the user clients.

Furthermore, in some embodiments, when a data transfer operation of the first user is complete, a contribution percentage for the data transferred by the first user when paying towards the target according to the target information may be determined. The contribution percentage may be determined based on a ratio of the amount subtracted from the first user's account to the total amount for the target and the result may be sent to the first user client 224. That is, when one user client transfers data through the data transfer interface, the server 222 may provide a contribution percentage of data transferred for a payment that is made by the user when paying the for the target according to the target information, to the user's client. For example, when the user A transfers 100 dollars for the target that costs 1000 dollars, the contribution percentage of data transferred that is determined for the user A's 100 dollar payment is 10%.

Moreover, in some embodiments a completion percentage of data transferred indication may be shown on a page that displays information of the data transfer interface and it may be updated in real time in order to prompt or inform visiting users as to how much of the total amount for the target has been transferred. For example, with respect to the user A, a completion percentage of data transferred indication for accumulated payments may be displayed on the data transfer interface page as 50% when user A visits the page, subsequently the completion percentage of data transferred indication may be updated to 60% when user A's data transfer operation is confirmed.

Moreover, in some embodiments, in order to improve participation in transferring data by users, the server 222 may send at least one of the completion percentage of data transferred indication and the contribution percentage of data transferred indication, which are determined for payments made for the target by users, to all user clients participating in transferring data, according to real-time transfers made by the user clients, for example, the initiating user client 220, the first user client 224 or other user clients that may transfer payments towards the target.

The server 222 may obtain the completion percentage of data transferred indication for the target information, which may include the users that actually participated in transferring data, and the amount of the value of the data that each user transferred according to interactions between the server 222 and the object server, and may determine at least one of the completion percentage of data transferred, the contribution percentage of data transferred indication for a user, and the accumulated amount of data transferred so far according to the data transfers completed and the percentage of the total amount transferred, and may send the results to the user clients.

In the process of opening a page in the data transfer interface and transferring data, there may be no need for a user to login repeatedly since the user who opened the page originally has already logged-in. Therefore, the user's client may directly perform a data transfer process according to the information from the user who has logged-in and any preset information related to data transfers, such as account information and bankcard information, which may greatly simplify the whole process.

In step 208, when the first user client 224 receives an actual transferred data indication for the target information, sent by the server 222, a completion percentage of data transferred for the target information may be determined by comparing the actual transferred data and a total amount or price associated with the target information.

In step 209, instances when the sum of the amount transferred through the data transfer interface is less than a total amount associated with the target information, within a second preset time limit, the data transfer interface may be closed, and the amount transferred by the users may be refunded to their accounts respectively.

In some embodiments, for data transfers with a time limit, it may be viable to limit the data transfer interface according to a time limit of the data transfer object, in order to ensure normal operation. For example, a data transfer process must be finished within three days; otherwise the goods will be released. In this situation, the data transfer interface has an expiry time limit. While in another embodiment of the present disclosure, the data transfer interface may be closed when the users fail to perform a data transfer operation within a first preset time limit, that is, a user client cannot transfer data through the data transfer interface. In other words, the page for transferring data may be invalid.

The first preset time limit and second preset time limit mentioned above may vary according to actual situations that occur for transferring data, and the disclosure is not limited to the specific types of time limits.

In step 210, the server 222 may send an indication of the actual transferred data for the target to the user clients that participated in transferring of data for the target, in instances when the sum of the amount transferred through the data transfer interface reaches the total amount or price for the target.

In instances when the sum of the amount transferred through the data transfer interface reaches the total amount or price for the target, the server 222 may send the actual transferred data for the target to the user clients that participated in transferring the data, to inform the user clients that the data transfer operation for the target information has finished. At this time, the data transfer interface may be closed so that other user clients may not be able to transfer data through the data transfer interface, thereby avoiding erroneous operations and so on.

Furthermore, an embodiment of the disclosure may comprises sending a current actual transferred data indication for data transferred by a second user for the target to a second user client (not shown in FIG. 2) when a request for querying the progress of data transferred is received from the second user. The second user client may not only be the user client that has performed data transfer operation for the target information, but also be all the user clients, which are not limited by the embodiment of the present disclosure. In order to ensure the security of the data transfer process, the second user client may be taken as the user client that has performed the data transfer operation for the target information.

Furthermore, an embodiment of the present disclosure may comprises sending a contribution percentage of data transferred indication for data transferred by a third user for paying for the target, to a third user client (not shown in FIG. 2) in instances when a request is received for querying a contribution percentage of data transferred from the third user. Since the third user client is the user client that has performed the data transfer operation for the target information, it may view its own contribution percentage of data transfer as well as the completion percentage of data transferred. Moreover, the server 222 may send the contribution percentage of data transferred and the completion percentage of data transferred to the third client directly, as well as, send actual transferred data by the third user or accumulated data transferred by the third user for the target information, and then calculate by the users. For example, taking user A mentioned above as the third user, the user A may view his or her own contribution percentage of data transferred for paying for the target and the completion percentage of data transferred, after transferring data. The viewing process may be done at any time after transferring data and the time of viewing may not be limited by whether the full payment for the target is finished or whether the data transfer interface is closed.

The process of providing the contribution percentage of data transferred and the completion percentage of data transferred by the server 222 may be realized by sending instant communication messages comprising a percentage of the transferred data due to a user's contribution and the degree of completion of a data transfer, the present percentage of contribution to the transfer data and the data transferring degree of completion to querying clients or to participating clients, for example, the user clients involved in transferring data or the initiating user client. In some embodiments the data transferred by comprise money.

The querying process may also be realized by sending instant communication messages to the server 222. For example, the user clients may send instant communication messages carrying a request for querying the completion percentage of data transferred to the server 222. Taking user A as an example, the user A may send a message for completing a data transfer comprising an order number and schedule to the server. The order may be a stated intention to engage in a commercial transaction for a product or service, for example. The order number may comprise a serial number or identification for the order and the schedule may indicate the rate of progress for the performance of the data transfer. The server 222 may judge whether user A once participated in the data transfer process of the order according to the identification and order number (that is the order identification in this embodiment) of user A after receiving the instant communication message. In instances when the server 222 determines that user A participated in the data transfer process, the server 222 may send a current completion percentage of data transferred corresponding to the order to user A.

Furthermore, the data transfer interface may be saved on the social information display platform of the initiating user client 220 to be viewed in the future. The data transfer interface may be may be accessed by means of keyword searching and user identification searching, which are not further described herein.

In a situation involving multiple users transferring data for a target where the transfer times vary, to make the progress of the data transfer process more clear, the status of the data transfer process may be indicated by the completion percentage of data transferred. In instances when none of the user clients has performed a data transfer operation, the completion percentage of data transfer may be zero, which may also be referred to as “not started” or “unpaid.” In instances when any of the user clients has transferred an amount corresponding to a completion percentage of data transferred of 25%, it may be referred to as “ongoing” or “25% completed.” In instances when the amount of data transferred is enough to satisfy the total amount or price of the target, the completion percentage of data transferred may be 100% which may be referred to as “completed.” Furthermore, in instances when all users refuse to pay the amount charged for a data transfer for a target or no user finishes his transfer in a preset time, the actual completion percentage of transferred data may be zero, and may be referred to as “invalid.” This embodiment is provided as an example of forms of presenting the completion percentage of data transferred, however, the disclosure is not limited in this regard.

In operation, a server creates a data transfer interface and publishes it on the social information display platform during a data transfer scenario. The social information display platform may serve as a host of the data transfer interface, without restricting specific users from executing data transfers. In this manner improvements are gained in the flexibility of transferring data and applying data transfers to different transfer situations and scenarios. Furthermore, the data transfer interface displayed on the social information display platform may be accessed based on a user logging onto a client, thereby improving security of the data transfer process and improving security of the user's account. However, avoiding security vulnerabilities may be difficult to manage when using URL data transferring.

It's important to note that the description above refers to a data transferring method for making a purchase as an example and is not limiting or exhaustive. The data transferring method described herein may also be applied to cases of initiating donations, initiating a purchase or an AA collection where multiple users each pay a portion of a price for something that may or may not be shared. The data to be transferred to an account may be, for example, currency, virtual currency or points; however, the disclosure is not limited in this regard.

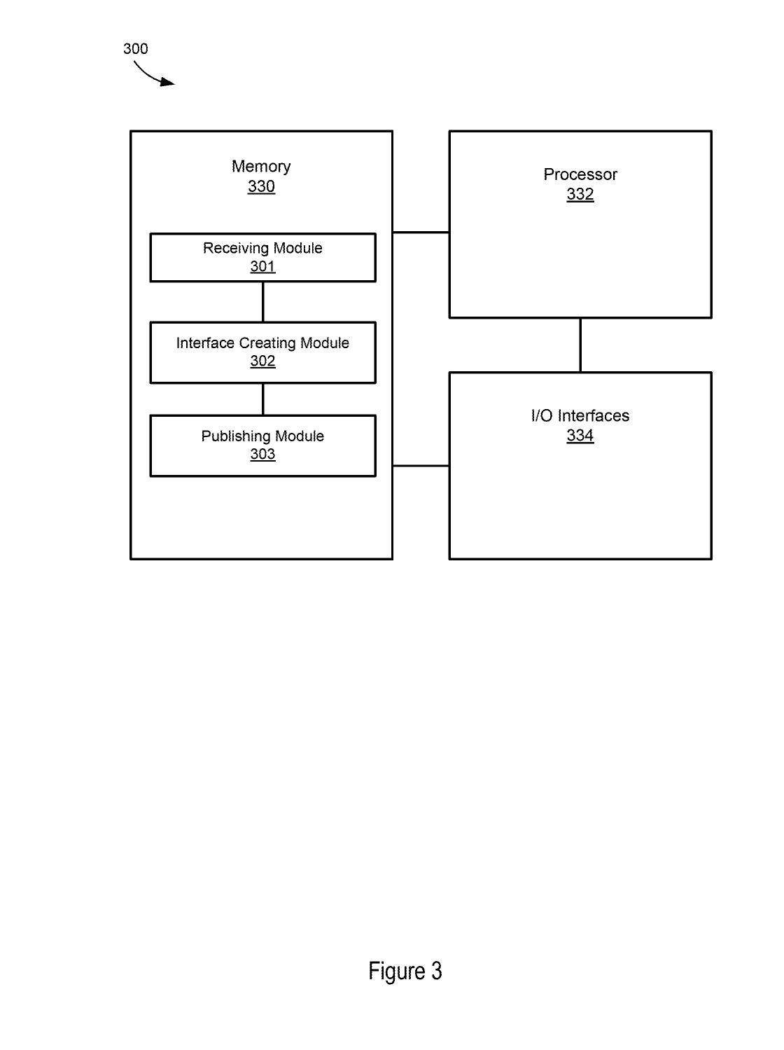

FIG. 3 is a block diagram that represents a server device for transferring data in accordance with an embodiment of the disclosure. Referring to FIG. 3, there is shown a device 300 that may comprise one or more memory devices 330, a receiving module 301, an interface module 302, a publishing module 303, one or more hardware processor 332 and one or more input-output (I/O) interfaces 334.

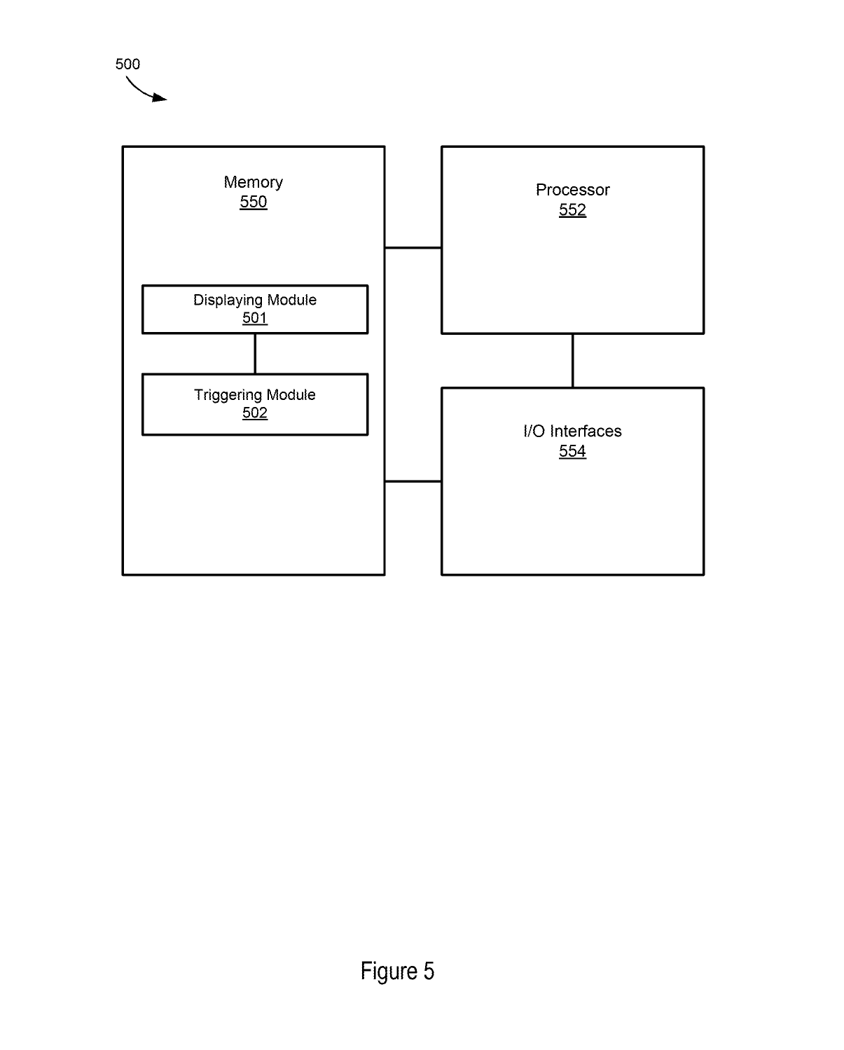

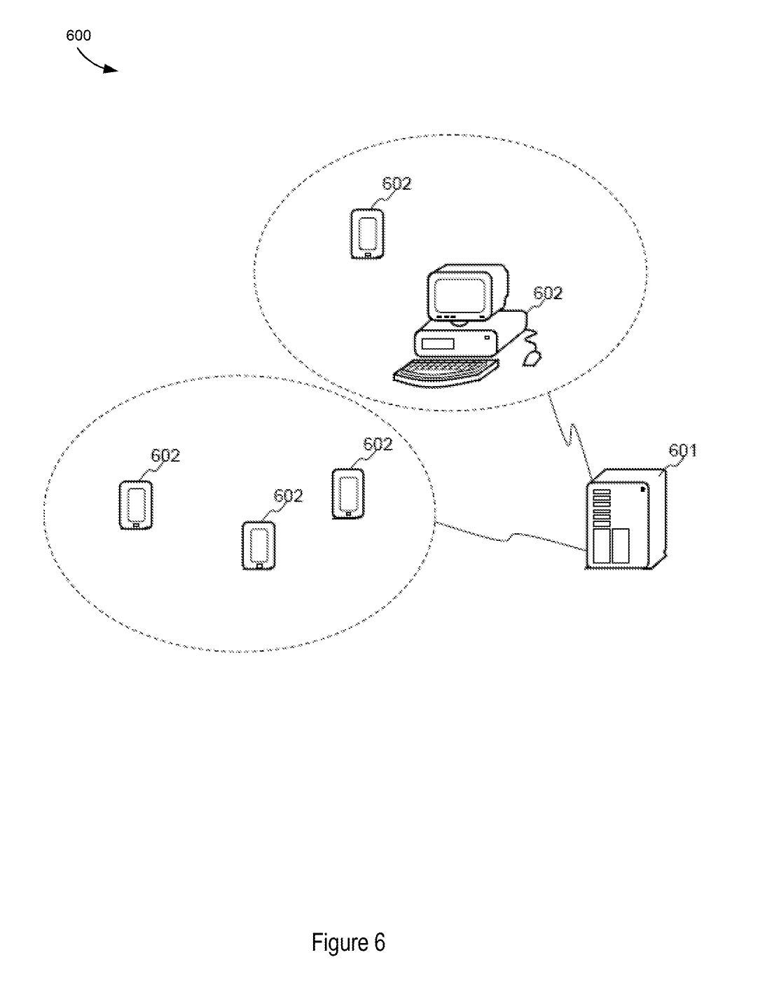

The data transferring device 300 may be similar or substantially the same as the server 222. The data transferring device 300 may comprise a computing and/or communication system that may include data transferring logic, which, when executed, may cause the data transferring device 300 to perform any of the logic and/or steps disclosed herein. The data transferring device 300 may operate as a standalone device or may be connected, for example, using a network or other connection, to other computer systems or peripheral devices, for example the data transferring device 500 (shown in FIGS. 5 and 6), the initiating user client 220 or first user client 224. The data transferring device 300 may be implemented through hardware, software, firmware or any combination thereof. Alternative software implementations may include, but are not limited to, distributed processing or component-object distributed processing, parallel processing, or virtual machine processing may also be constructed to implement the data transfer methods described herein.

In a network deployment, the data transferring device 300 may operate in the capacity of a server for example the server 222 in a server-client user network environment, as a user client computer or as a peer computer system in a peer-to-peer (or distributed) network environment. The data transferring device 300 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, or any other machine capable of executing the data transferring logic that specifies actions to be taken by that machine. The data transferring device 300 may comprise electronic devices that provide voice, video or data communication. The system implementation of the data transferring device 300 may comprise a single computer system, or may include any collection of systems or sub-systems that individually or jointly execute a set, or multiple sets, of instructions to perform any of the processing for the transferring of data or exchange of money, virtual money or points and communications noted above.

The data transferring device 300 may include the one or more processors 332, for example, a central processing unit (CPU), a graphics processing unit (GPU) or both. A processor may be implemented as a controller, microprocessor, digital signal processor, microcontroller, application specific integrated circuit (ASIC), discrete logic, or a combination of other types of circuits or logic. The data transferring device 300 may further include a display such as a liquid crystal display (LCD), an organic light emitting diode (OLED), a flat panel display, a solid state display, or a cathode ray tube (CRT).

The one or more I/O interface devices 334 may include any suitable type of I/O interface for wireless, wire line and/or optical communication between the data transferring device 300 and another device or network. For example, the data transferring device 300 may be communicatively coupled to one or more devices such as, for example, the data transferring device 500 (shown in FIG. 5), the initiating user client 220 or first user client 224 and/or a network.

The one or more memory devices 330 may include, but may not be limited to internal and/or external computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some embodiments, the memory 330 may include a cache or random access memory for the one or more processors 332. Alternatively or in addition, the memory 330 may be separate from the one or more processors 332, such as a cache memory of a processor, the system memory, or other memory.

Moreover, the one or more memory devices 330 may comprise a non-transitory computer readable medium having stored thereon one or more instructions for transferring data. For example, the one or more instructions for transferring data may comprise the receiving module 301, the interface creating module 302 and the publishing module 303. The one or more instructions may be executable by the one or more processors 332 to cause the one or more processors 332 to perform steps for transferring data described with respect to the server 222, for example. The data transferring device 300 may be communicatively coupled to one or more client devices by one or more input or output (I/O) interfaces 334, for example, a wireless, wire-line or optical interface.

The receiving module 301 may be operable to receive a request for transferring data from an initiating user client 220. The request for transferring data may include at least initiating user identification and target information.

The interface creating module 302 may be operable to create a data transfer interface that corresponds to a target according to the target information. The publishing module 303 may be operable to publish the data transfer interface on a social information display platform that corresponds to the initiating user identification.

In some embodiments, the device 300 may include a data transferring module, that is operable to receive a trigger request from a first user, for triggering the data transfer interface to call a first account corresponding to or associated with the first user, subtract an amount indicated by the first user from the first account, and add the subtracted amount to a second account that corresponds to or is associated with the target information.

In some embodiments, the interface creating module may further be operable to obtain a second account corresponding to or associated with the target according to the target information. The second account may be identified as a target transfer account of the data transfer interface.

In some embodiments, the device 300 may comprise an upper limit determining module that may be operable to determine a total amount for the target according to the target information. The total amount may be utilized as an upper limit of the value of the data to be transferred through the data transfer interface.

In some embodiments, the device 300 may comprise a lower limit determining module may be operable to obtain a minimum transfer amount for the target information and may utilize the minimum transfer amount as a lower limit for data to be transferred through the data transfer interface.

In some embodiments, the device 300 may comprise a first sending module that may be operable to send an actual transferred data indication for the target information to the first user client 220 according to the amount subtracted from the first account and transferred through the data transfer interface when the data transfer operation of the first user is complete.

In some embodiments, the device 300 may comprise a second sending module may be operable to send an actual transferred data indication for the target information to user clients that participated in transferring data in instances when a sum of the amounts or value of money transferred through the data transfer interface reaches the total amount or price for the target.

In some embodiments, the device 300 may comprise a third sending module may be operable to send a contribution percentage of transferred data which corresponds to the amount transferred by a first user for paying for the target, to the first user client 224. The contribution of percentage of transferred data may be based on a ratio of the amount subtracted from the first account to the total amount or price of the target, in instances when the data transfer operation of the first user is complete.

In some embodiments, the device 300 may comprise a first processing module that may be operable to close the data transfer interface in instances when a data transfer operation fails to be performed by any user within a first preset time.

In some embodiments, the device 300 may comprise a second processing module may be operable to close the data transfer interface and refund the amounts transferred by the users to their own accounts respectively when the sum of the amounts transferred through the data transfer interface is less than the total amount or price that corresponds to the target within a second preset time period.

In some embodiments, the device 300 may comprise a forth sending module that may be operable to send a current actual transferred data for the target information made by a second user indication to a second user client when a request querying the progress of data transferred is received from the second user.

In some embodiments, the device 300 may comprise a fifth sending module may be operable to send a contribution percentage of data transferred made by a third user for paying for the target, to a third user client when a request for querying a contribution percentage of data transfer is received from the third user.

Additional embodiments may be realized by combining any of the described embodiments mentioned above, each of which are not listed here.

It should be noted that, the description above merely describes an example for dividing the data processing device into several functional modules, but in the practical application, different functional modules can be distributed to perform the functions mentioned above, that is, the interior structure of the device can be divided into several functional modules to perform the partial or whole functions. In addition, the data transferring device and the method thereof pertain to the same concept, whose process could be reviewed in the embodiments related to the method, thus is not repeated here.

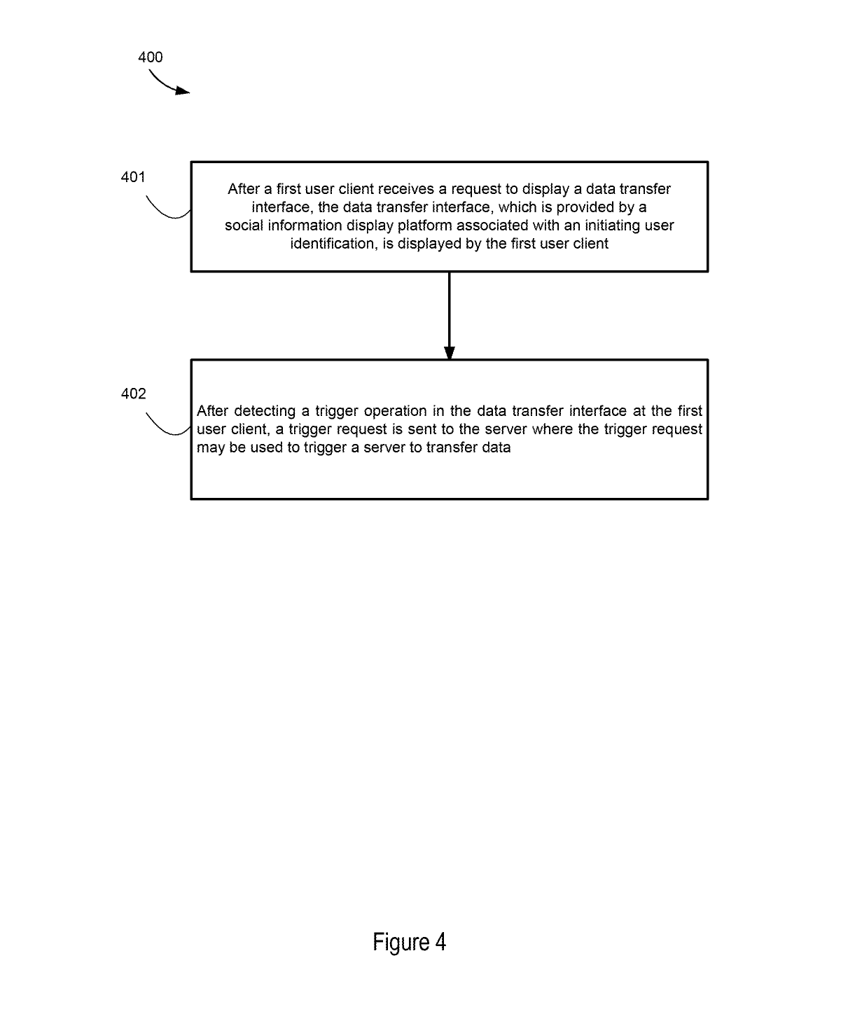

FIG. 4 is a flowchart for transferring data in accordance with an embodiment of the disclosure. As shown in FIG. 4, a method for transferring data may comprise the following steps.

In step 401, the first user client 224 may receive a request from the first user to display the data transfer interface. After receiving the request, the data transfer interface may be displayed on the first user client 224. The data transfer interface may be provided by a social information display platform of the initiating user who corresponds to the initiating user identification. In step 402, a trigger request may be sent to the server 222 after a trigger operation is detected in the data transfer interface. The trigger request may be used to trigger the server 222 to transfer data.

In some embodiments, the method may further comprise receiving an actual transferred data indication for the target information, which may be sent by the server 222. A completion percentage of data transferred may be determined for the target information by calculating based on the actual transferred data for the target relative to the total amount or price corresponding to the target according to the target information.

In some embodiments a contribution percentage of data transferred indication may be determined for a first account for paying for the target according to the target information by calculating based on an amount subtracted from the first account and the total amount or price corresponding to the target according to the information.

FIG. 5 is a block diagram that represents a client device for transferring data in accordance with an embodiment of the disclosure. Referring to FIG. 5, there is shown a device 500 that may comprise one or more memory devices 550, a displaying module 501, a triggering module 502, one or more hardware processors 552 and one or more input-output (I/O) interfaces 554.

The data transferring device 500 may be similar or substantially the same as the initiating user client 220 or the first user client 224, for example. The data transferring device 500 may comprise a computing and/or communication system that may include data transferring logic, which, when executed, may cause the data transferring device 500 to perform any of the logic and/or steps disclosed herein. The data transferring device 500 may operate as a standalone device or may be connected, for example, using a network or other connection, to other computer systems or peripheral devices, for example the data transferring device 300 (shown in FIGS. 3 and 6) or the server 222. The data transferring device 500 may be implemented through hardware, software, firmware or any combination thereof. Alternative software implementations may include, but are not limited to, distributed processing or component-object distributed processing, parallel processing, or virtual machine processing may also be constructed to implement the data transfer methods described herein.

In a network deployment, the data transferring device 500 may operate in the capacity of a client for example the initiating user client 220 or the first user client 224 in a server-client user network environment, as a server computer or as a peer computer system in a peer-to-peer (or distributed) network environment. The data transferring device 500 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, or any other machine capable of executing the data transferring logic that specifies actions to be taken by that machine. The data transferring device 500 may comprise electronic devices that provide voice, video or data communication. The system implementation of the data transferring device 500 may comprise a single computer system, or may include any collection of systems or sub-systems that individually or jointly execute a set, or multiple sets, of instructions to perform any of the processing for the transferring of data or exchange of money, virtual money or points and communications noted above.

The data transferring device 500 may include the one or more processors 552, for example, a central processing unit (CPU), a graphics processing unit (GPU) or both. A processor may be implemented as a controller, microprocessor, digital signal processor, microcontroller, application specific integrated circuit (ASIC), discrete logic, or a combination of other types of circuits or logic. The data transferring device 500 may further include a display such as a liquid crystal display (LCD), an organic light emitting diode (OLED), a flat panel display, a solid state display, or a cathode ray tube (CRT).

The one or more I/O interface devices 554 may include any suitable type of I/O interface for wireless, wire line and/or optical communications between the data transferring device 500 and another device or network. For example, the data transferring device 500 may be communicatively coupled to one or more devices such as, for example, the data transferring device 500 (shown in FIGS. 5 and 6), the initiating user client 220 or first user client 224 and/or a network.

The one or more memory devices 550 may include, but may not be limited to internal and/or external computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some embodiments, the memory 550 may include a cache or random access memory for the one or more processors 552. Alternatively or in addition, the memory 550 may be separate from the one or more processors 552, such as a cache memory of a processor, the system memory, or other memory.

Moreover, the one or more memory devices 550 may comprise a non-transitory computer readable medium having stored thereon one or more instructions for transferring data. For example, the one or more instructions for transferring data may comprise the displaying module 501 and/or the triggering module 502. The one or more instructions may be executable by the one or more processors 552 to cause the one or more processors 552 to perform steps for transferring data described with respect to the initiating user client 220 or first user client 224, for example. The data transferring device 500 may be communicatively coupled to one or more server devices by one or more of the input or output (I/O) interfaces 554, for example, a wireless, wire-line or optical interface.

The displaying module 501 may be operable to display a data transfer interface that may be provided by a social information display platform of an initiating user associated with the initiating user identification, after a first user client receives a request for displaying the data transfer interface.

The triggering module 502 may be operable to send a trigger request to a server, for example, the server 222 or the device 300, after detecting a trigger operation in the data transfer interface where the request may be used to trigger the server 222 to transfer data in accordance with an embodiment of the disclosure.

In some embodiments, the device 500 may comprise a first counting module that may be operable to receive an actual transferred data indication for the target associated with the target information, sent by the serve, and may determine a completion percentage of data transferred indication for the target associated with the information, based on the actual transferred data indication and a total amount or price corresponding to the target information.

In some embodiments, the device 500 may comprise a second counting module that may be operable to obtain a contribution percentage of data transferred indication for a payment made for the target from a first account by determining an amount subtracted from the first account when paying for the target relative to the total amount or price of the target according to the target information.

Those skilled in the art may understand that the whole or part of the steps described above may be realized by hardware and/or by software programs that may instruct the hardware. The programs may be stored in a computer readable storage medium, the storage medium mentioned above may be read-only memory, disk or CD, for example.

FIG. 6 is a block diagram of a data transferring system according to one embodiment of the disclosure. Referring to FIG. 6, there is shown a system 600 that may comprise a server device 601 and one or more client devices 602.

The server device 601 may be communicatively coupled to the one or more client devices 602. In some embodiments, the server device 601 and the one or more client devices 602 may communicate via any suitable network, for example, a wireless, wire-line or optical network, utilizing any suitable communication technology.

The server device 601 may be similar or substantially the same as the server 222 and/or the data transfer device 300. The server device 601 may be operable to receive a request for transferring data from a client device 602 that may be similar or substantially the same as the initiating user client 220. The request may include an initiating user identification that corresponds to an initiating user, and target information associated with a target for which data may be transferred as described above with respect to FIGS. 1-5. The server device 601 may be operable to create a data transfer interface that may correspond to the target according to the target information as described with respect to FIGS. 1-5. Furthermore, the server device 601 may be operable to publish the data transfer interface on a social information display platform of the initiating user associated with the initiating user identification.

The one or more client devices 602, may be substantially the same as the initiating client device 220, the first user client 224 and/or the data transferring device 500. The one or more client devices 602 may be operable to initiate a request for transferring data as described with respect to FIGS. 1-5.

The one or more client devices 602 may be operable to display a data transfer interface that may be provided by a social information display platform of an initiating user associated with the initiating user identification, after receiving the request for displaying the data transfer interface as described with respect to FIGS. 1-5. The one or more client devices 602 may be operable to send a trigger request to a server after detecting a trigger operation in the data transfer interface, where the trigger request may be used to trigger the server device 601 to transfer data as described with respect to FIGS. 1-5.

While various embodiments, features, and benefits of the present system have been described, it will be apparent to those of ordinary skill in the art that many more embodiments, features, and benefits are possible within the scope of the disclosure. For example, other alternate systems may include any combinations of structure and functions described above or shown in the figures.

What is claimed is:

1. A method for transferring data, the method comprising:
receiving a request for transferring data from an initiating user client, wherein the request for transferring data includes at least an initiating user identification and target information;
creating a data transfer interface that corresponds to a target according to the target information; and
publishing the data transfer interface on a social information display platform of an initiating user associated with the initiating user identification, wherein the data transfer interface is operable to be utilized for transferring data associated with the target.

2. The method according to claim 1 further comprising:
in instances when said data corresponds to a first account having a value representing a medium of exchange:
obtaining a second account that corresponds to the target according to the target information, said second account having a value representing a medium of exchange; and
assigning the second account as a receiving account for the data transfers that utilize the data transfer interface.

3. The method according to claim 2 further comprising:
receiving a trigger request from a first user client for triggering the data transfer interface to call the first account that corresponds to a first user, subtracting an amount indicated by the first user from the first account, and adding a corresponding amount to the second account that corresponds to the target.

4. The method according to claim 3, further comprising one or both of:
obtaining a total amount asked for the target according to the target information, and utilizing the total amount asked as an upper limit for the value of the data to be transferred through the data transfer interface; and
obtaining a minimum transfer amount for the target, and utilizing the minimum transfer amount as a lower limit for the value of the data to be transferred through the data transfer interface.

5. The method according to claim 4, further comprising at least one of:
in instances when a data transfer operation triggered by the first user client is complete, sending an actual transferred data indication to the first user client according to the amount subtracted from the first account and transferred using the data transfer interface;
in instances when a sum of one or more amounts corresponding to data transferred for the target using the data transfer interface, reaches the total amount asked for the target, sending an actual transferred data indication representing the sum to one or more user clients that participated in transferring the data for the target; and
in instances when the data transfer operation of the first user is complete, sending to the first user client, an indication of a percentage of the amount asked for the target that was contributed by the first user, based on a ratio of the amount subtracted from the first account to the total amount asked for the target.

6. The method according to claim 1, further comprising:
in instances when a data transfer operation is not performed by any user within a first time limit, closing the data transfer interface; or
in instances when a sum of the amounts in one or more data transfers made within a second time limit by one or more users utilizing the data transfer interface is less than a total amount asked for the target, closing the data transfer interface and refunding the one or more amounts transferred by the one or more users to their own accounts respectively.

7. The method according to claim 1, further comprising:
when receiving a request for querying progress of a data transfer from a second user, sending an indication of current actual transferred data for the target made by the second user to a second user client; or
when receiving a request to query a contribution percentage for data transferred from a third user, sending to a third user client, an indication of a percentage of an amount asked for the target that was contributed by the third user in a data transfer when paying for the target.

8. A device for transferring data, wherein the device comprises one or more hardware processors and/or circuits that are operable to:
in a receiving module, receive a request for transferring data from an initiating user client, wherein the request for transferring data includes at least an initiating user identification and target information;
in an interface creating module, create a data transfer interface that corresponds to a target according to the target information; and
in a publishing module, publish the data transfer interface on a social information display platform of an initiating user associated with the initiating user identification, wherein the data transfer interface is operable to be utilized for transferring data associated with the target.

9. The device according to claim 8, wherein in instances when said data corresponds to a first account having a value representing a medium of exchange, said one or more hardware processors and/or circuits are operable to:
obtain a second account that corresponds to the target according to the target information, said second account having a value representing a medium of exchange; and
assign the second account as receiving account for the data transfers that utilize the data transfer interface.

10. The device according to claim 9, wherein the one or more hardware processors or circuits are operable to in a data transferring module:
receive a trigger request from a first user client for triggering the data transfer interface to call a first account that corresponds to a first user;
subtract an amount indicated by the first user from the first account; and
add a corresponding amount to the second account that corresponds to the target.

11. The device according to claim 10, wherein the one or more hardware processors and/or circuits are operable to at least one of:
in an upper limit determining module, obtain a total amount asked for the target according to the target information, and utilizing the total amount asked as an upper limit for the value of the data to be transferred through the data transfer interface; and
in a lower limit determining module, obtain a minimum transfer amount for the target, and utilizing the minimum transfer amount as a lower limit for the value of the data to be transferred through the data transfer interface.

12. The device according to claim 11, wherein the one or more hardware processors and/or circuits are operable to:
in a first sending module, send an actual transferred data indications to the first user client according to the amount subtracted from the first account and transferred using the data transfer interface in instances when a data transfer operation triggered by the first user client is complete;
in a second sending module, send an actual transferred data indication that represents a sum of one or more amounts corresponding to the data transferred for the target using the data transfer interface, to one or more user clients that participated in transferring the data in instances when the sum reaches the total amount asked for the target; and
in a third sending module, send to the first user client, an indication of a percentage of the amount asked for the target that was contributed by the first user when paying for the target, based on a ratio of the amount subtracted from the first account to the total amount asked for the target, in instances when the data transfer operation of the first user is complete.

13. The device according to claim 8, wherein the one or more hardware processors and/or circuits are operable to:
in a first processing module, close the data transfer interface in instances when the data transfer operation is not performed by any user within a first time limit; or
in a second processing module, close the data transfer interface and refund one or more amounts transferred by one or more users to their own accounts respectively in instances when a sum of the amounts in one or more data transfers made within a second time limit by the one or more users utilizing the data transfer interface is less than a total amount asked for the target.

14. The device according to claim 8, wherein the one or more hardware processors and/or circuits are operable to:
in a fourth sending module, send an indication of current actual transferred data for the target made by the second user to a second user client when receiving a request for querying progress of a data transfer from a second user; or
in a fifth sending module, send to a third user client, an indication of a percentage of an amount asked for the target, that was contributed by the third user in a data transfer when paying for the target, when receiving a request to query a contribution percentage for data transferred from a third user.

15. A device for transferring data, wherein the device comprises one or more hardware processors and/or circuits that are operable to:
in a displaying module, display a data transfer interface, wherein the data transfer interface is provided by a social information display platform that is associated with an initiating user identification for transferring data based on information associated with a target, after a first user client receives a request to display the data transfer interface; and
in a triggering module, send a trigger request to a server after detecting a trigger operation in the data transfer interface, wherein the trigger request is used for triggering the server to transfer data.

16. The device according to claim 15, wherein the one or more hardware processors and/or circuits are operable to, at least one of:
in a first counting module, receive an indication of actual transferred data for the target, wherein the indication is sent by the server, and determine a completion percentage of data transferred for the target based on the actual transferred data indication and a total amount asked for the target; and
in a second counting module, obtain a contribution percentage for data transferred from a first account in for paying the target based on a ratio of an amount subtracted from the first account and the total amount corresponding to the target information.
